(19) United States
(12) Patent Application Publication
(10) Pub. No.: US 2011/0316915 A1
(43) Pub. Date: Dec. 29, 2011

(54) LIQUID EJECTING APPARATUS AND METHOD OF CONTROLLING SAME

(75) Inventor: Junichiro MATSUSHITA, Matsumoto-shi (JP)

(73) Assignee: SEIKO EPSON CORPORATION, Tokyo (JP)

(21) Appl. No.: 13/088,174

(22) Filed: Apr. 15, 2011

(30) Foreign Application Priority Data
Jun. 24, 2010 (JP) 2010-143786

(51) Int. Cl. B41J 29/38

(52) U.S. Cl. 347/10

(57) ABSTRACT

The driving signal generation circuit generates a first driving signal which includes a first ejection driving pulse in a unit period and a second driving signal which includes a second ejection driving pulse which is generated before the first ejection driving pulse in the unit period. The printer controller and the head control section correct the waveform of either one of the first ejection driving pulse or the second ejection driving pulse in accordance with a temperature that is detected by the temperature sensor.

### CROSS-REFERENCE TO RELATED APPLICATION

This application claims priority to Japanese Patent Application No: 2010-143786, filed on Jun. 24, 2010, which is expressly incorporated by reference herein in its entirety.

### BACKGROUND

1. Technical Field

Embodiments of the present invention relate to a liquid ejecting apparatus, such as an ink jet type recording apparatus, and a method of controlling a liquid ejecting apparatus and, in particular, to a liquid ejecting apparatus capable of controlling ejection of liquid by using a plurality of driving signals and to a method of controlling such a liquid ejecting apparatus.

2. Related Art

A liquid ejecting apparatus is an apparatus that is provided with a liquid ejecting head that is capable of ejecting liquid in the form of individual liquid droplets. The liquid ejecting apparatus ejects various liquids from the liquid ejecting head. For example, a representative example of a liquid ejecting apparatus is an image recording apparatus, such as an ink jet type recording apparatus (hereinafter referred to as a printer). The printer is provided with an ink jet type recording head (hereinafter referred to as a recording head) and performs recording by ejecting ink from the recording head in the form of liquid ink droplets. Also, in recent years, the liquid ejecting apparatus has also been applied to various manufacturing apparatuses such as a display manufacturing apparatus, without being limited to the image recording apparatus.

In the above-described printer, for example, an ink droplet is ejected from a nozzle of the recording head by generating a driving signal that causes pressure fluctuation to be applied to ink in a pressure chamber. The driving signal includes a plurality of successive driving pulses that are selectively supplied to a pressure generation section, such as a piezoelectric vibrator or a heat generation element, thereby driving the pressure generation section, and also thereby controlling the pressure fluctuation. As a type of such a printer, there is a conventional apparatus that is configured so as to perform multi-gradation recording by changing the size or the number of dots which are formed within a given area (pixel area) of a recording medium (landing target) such as printer paper (refer to JP-A-2005-125804, for example).

In the printer which is disclosed in JP-A-2005-125804 described above, two driving signals COM1 and COM2 are simultaneously generated in a periodic time interval T. In the driving signal COM1, two driving pulses for a middle dot formation are included. In the driving signal COM2, one driving pulse for a small dot formation is included. Then, the driving pulse of the driving signal COM2 is selected to form a small dot with respect to the pixel area of the recording medium, one of the driving pulses of the driving signal COM1 is selected to form a middle-sized dot, the two driving pulses of the driving signal COM1 are selected to form a large dot, and micro-vibration is performed if a dot is not formed. Therefore, according to this configuration, recording can be performed with four gradations of dot size.

In this manner, it is possible to increase the number of gradations by adopting a configuration in which each of the driving signals COM1 and COM2 includes many different kinds of driving pulses and one or multiple combinations of the different kinds of driving pulses are applied to the pressure generation section. For example, a configuration may permit a plurality of driving pulses to be continuously applied in combination to the pressure generation section, causing ejection of a larger amount of ink than the maximum amount (measured by weight or volume) of ink that is obtained by a single ejection from the nozzle in the periodic time interval.

Incidentally, in a case where a difference in dot size between the respective gradations is large, the roughness (hereinafter referred to as granularity) of an image visible in an image or the like that is recorded on the recording medium may be conspicuous. In order to improve such granularity, the difference in the amount of ink (that is, dot size) between gradations may be made as small as possible. For example, the configuration illustrated in JP-A-2005-125804 described above is for four gradations, whereas, if a configuration capable of attaining twice that, eight gradations, is adopted, since a difference in the amount of ink between gradations becomes smaller, granularity is further refined. However, in a case where the number of gradations is simply increased, since the kind of driving pulses becomes larger by a corresponding number, the periodic time interval T of the driving signal becomes longer. As a result, the recording speed may be slowed down. For this reason, it is necessary to make the driving pulses be more efficiently included in a limited periodic time interval T.

Furthermore, just after an ink droplet is ejected from the nozzle by applying the driving pulse to the pressure generation section, residual vibration is generated in the ink near the nozzle. The residual vibration is vibration in which the vibration of the natural vibration period Tc of the ink in the pressure chamber is superimposed on the vibration of a meniscus in the nozzle. The vibration of the natural vibration period Tc displaces the meniscus at a very short period of several microseconds (μs). The vibration of this period Tc possibly affects ejection of the next ink droplet. Specifically, in accordance with a phase of the vibration of the period Tc at the time of ejection, the flying speed of the ejected ink droplet changes or an amount of liquid changes. Such variation in the flying speed of the ejected ink droplet or the amount of liquid (hereinafter appropriately referred to as ejection characteristics) causes deviation of a landing position on the recording medium or variation in the size of a dot, leading to a resulting quality deterioration of the recorded image.

The above Tc is uniquely determined by the shape, the dimension, the stiffness, and the like of each constituent member such as the nozzle, the pressure chamber which communicates with the nozzle, the ink supply port that communicates with a common liquid chamber and the pressure chamber, and the piezoelectric vibrator. The natural vibration period Tc can be expressed, for example, by the following expression (1).

Tc=2π√[[(Mn×Ms)/(Mn+Ms)]×Cc] (1)

In the expression (1), Mn is an inertance in the nozzle, Ms is an inertance in the ink supply port, and Cc is compliance (a volume change per unit pressure, representing the degree of softness) of the pressure chamber. Also, in the above expression (1), an inertance M represents ease of movement of liquid in a flow path such as the nozzle and, in the other words, is a mass of liquid per unit cross-section area. For example, when the density of fluid is ρ, a cross-sectional area of a surface perpendicular to a fluid flow direction in the flow path is S, and the length of the flow path is L, the inertance M can be approximately expressed by the following expression (2).

M=(ρ×L)/S (2)

In addition, Tc is not limited to the definition of the above expression (1), but may be the vibration period of the pressure chamber of the recording head.

In order to record a high-quality image by precisely landing ink droplets onto the recording medium, it is important to make ejection characteristics constant. In particular, as described above, in a configuration in which ink is ejected by the combination of a plurality of driving pulses in the periodic time interval T, since an ejection might be performed before residual vibration accompanying an immediately preceding ejection is controlled, a temporal relationship (between the respective driving pulses of the driving signals is preferably determined such that the combination of consecutive driving pulses cause a desired or target value of total amount of ink to be ejected, in consideration of the residual vibration.

However, in a configuration in which the driving signal has the temporal relationship between respective driving pulses set as described above, the actual ejected amount of ink may vary from the desired ejected amount of ink due to differences between an environmental temperature and a reference temperature (for example, 25° C.) defined in a specification. That is, since the amplitude of residual vibration or the like also changes due to a change in viscosity of ink according to a change in temperature, the total amount of ink ejected as a result of the combination of consecutive driving pulses might not reach the above-described target value due to the influence of a change in the residual vibration.

In addition, such a problem not only occurs in an ink jet recording apparatus with an ink jet type recording head that ejects ink droplets, but also occurs in likewise fashion in a liquid ejecting apparatus with another type of liquid ejecting head that ejects liquid droplets other than ink.

### SUMMARY

In general, example embodiments of the invention relate to a liquid ejecting apparatus and a method of controlling same that suppress an influence of a change in temperature on the ejection of liquid when combining a plurality of driving pulses in a periodic time interval.

According to a first embodiment of the invention, a liquid ejecting apparatus includes: a liquid ejecting head configured to eject liquid from a nozzle in response to pressure from a pressure generation section; a driving signal generation section configured to generate a plurality of driving signals, each of the driving signals including a plurality of driving pulses repeated in periodic time intervals, the driving pulses being configured to control an amount of pressure generated by the pressure generating section; a selection control section configured to apply selected ones of the driving pulses included in the driving signals to the pressure generation section; a temperature detection section configured to detect a temperature of the inside of the liquid ejecting apparatus; and a waveform correction section configured to control the driving signal generation section to correct a waveform of one of a first driving pulse of a first one of the driving signals and a second driving pulse of a second one of the driving signals, the second driving pulse preceding but occurring within the same periodic time interval as the first driving pulse. The waveform correction section corrects the waveform of one of the first and second driving pulses based on the temperature that is detected by the temperature detection section.

According to the above first embodiment, since the waveform of either one of the first driving pulse or the second driving pulse is corrected based on a temperature that is detected by the temperature detection section, if liquid is ejected twice from the nozzle by respectively selecting the second driving pulse and the first driving pulse in the same periodic time interval and then applying the selected pulses to the pressure generation section, the total amount of ejected liquid can be brought close to a target value regardless of the environmental temperature. As a result, variations in temperature cause less variation in the position or the size of a dot formed on a landing target.

In the above first embodiment, each of the waveforms of the first driving pulse and the second driving pulse may include at least a first change portion in which an electric potential changes to a first polarity, a maintaining portion that maintains a final electric potential of the first change portion for a predetermined length of time, and a second change portion in which an electric potential changes from the final electric potential of the maintaining element to a second polarity opposite to the first polarity. The waveform correction section may control the driving signal generation section to correct the waveform by changing a duration of at least one of the first change portion, the maintaining portion, and the second change portion of the corrected waveform.

In addition, the “duration of a waveform portion ” means a time from the beginning to the end of the waveform portion.

Also, in the above first embodiment, the waveform correction section may control the driving signal generation section to correct the waveform by changing an amplitude of the corrected waveform.

In the above first embodiment, the first driving pulse may be selected only in combination with the second driving pulse, and the waveform correction section may make the driving signal generation section correct the waveform of the second driving pulse in accordance with a temperature that is detected by the temperature detection section.

Since the waveform of the first driving pulse that is selected only in combination with the second driving pulse is corrected based on a detected temperature, that is, since the second driving pulse is not corrected, an amount of liquid ejected from the nozzle is prevented from being unnecessarily varied by selecting only the second driving pulse in the periodic time interval and then applying it to the pressure generation section. Also, requiring correction of only the first driving pulse of the two driving signals and not of the second driving pulse simplifies a correction process or a circuit configuration.

In the above first embodiment, each of the first and second driving signals may include in each of the periodic time intervals a largest driving pulse that causes a larger amount of pressure to be generated by the pressure generation section than either of the first and second driving pulses taken individually. In addition, each of the first and second driving signals may further include, in each of the periodic time intervals, one or more other driving pulses, each of which causes a smaller amount of pressure to be generated by the pressure generation section than either of the first and second driving pulses taken individually. Moreover, an interval between generation of the largest driving pulse of the first driving signal and the largest driving pulse of the second driving signal in the same periodic time interval may be closer to half of the periodic time interval than an interval between generation of the first driving pulse and the second driving pulse, the interval between generation of the first driving pulse and the second driving pulse in the periodic time interval may be shorter than the interval between generation of the largest driving pulses in the periodic time interval, and another driving pulse or one of the largest driving pulses may be generated after both the first driving pulse and the second driving pulse in the periodic time interval.

According to a second embodiment of the invention, there is provided a method of controlling a liquid ejecting apparatus that includes a liquid ejecting head configured to eject liquid from a nozzle in response to pressure from a pressure generation section. The method may include generating a plurality of driving signals, each of the driving signals including a plurality of driving pulses repeated in periodic time intervals, the driving pulses being configured to control an amount of pressure generated by the pressure generating section. The method may further include applying selected ones of the driving pulses included in the driving signals to the pressure generation section and detecting a temperature of the inside of the liquid ejecting apparatus. In addition, the method may include correcting a waveform of one of a first driving pulse of a first one of the driving signals and a second driving pulse of a second one of the driving signals based on the temperature that is detected by the temperature detection section. The second driving pulse may precede but occur within the same periodic time interval as the first driving pulse.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

Aspects of example embodiments of the invention will become apparent from the description of the accompanying drawings, wherein like numbers reference like elements.

FIG. 1 is a block diagram illustrating an electrical configuration of a printer;

FIG. 2 is a perspective view illustrating an internal configuration of the printer of FIG. 1;

FIG. 3 is a cross-sectional view of a main section of a recording head in the printer of FIGS. 1 and 2;

FIG. 4 is a plan view illustrating the configuration of a nozzle plate in the recording head of FIG. 3;

FIG. 5 is a waveform diagram illustrating configurations of driving signals and a table of pixel gradations and corresponding selection data;

FIG. 6 is a waveform diagram illustrating a configuration of a first ejection driving pulse;

FIG. 7 is a waveform diagram illustrating a configuration of a second ejection driving pulse;

FIG. 8 is a waveform pattern illustrating two instances of the second ejection driving pulse of FIG. 7 combined in a unit period;

FIG. 9 is a graph illustrating a change in the total amount of ink that is ejected by the combination of ejection driving pulses in the waveform pattern of FIG. 8;

FIGS. 10A to 10F are tables showing specific examples of corrections of the waveform pattern of FIG. 8; and

FIG. 11 is a waveform diagram illustrating configurations of driving signals according to another embodiment of the invention.

### DESCRIPTION OF EXEMPLARY EMBODIMENTS

Hereinafter, various embodiments of the invention will be described with reference to the accompanying drawings. In addition, although in the embodiments which are described below, various limitations are given as preferred specific examples of the invention, the scope of the invention is not to be limited to these aspects unless expressly stated hereinafter. Also, an ink jet type recording apparatus (hereinafter referred to as a printer) is described only as an example of a liquid ejecting apparatus according to embodiments described herein.

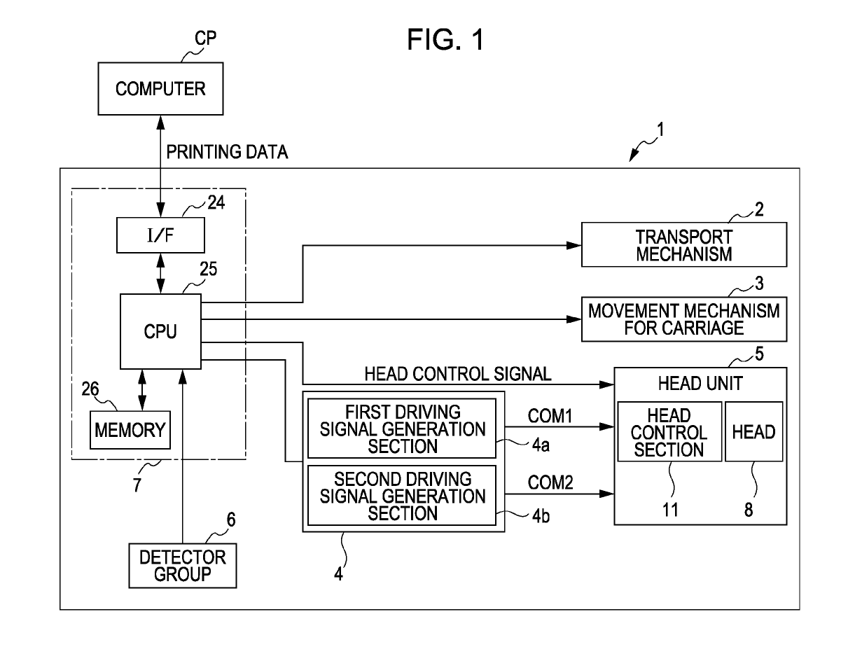

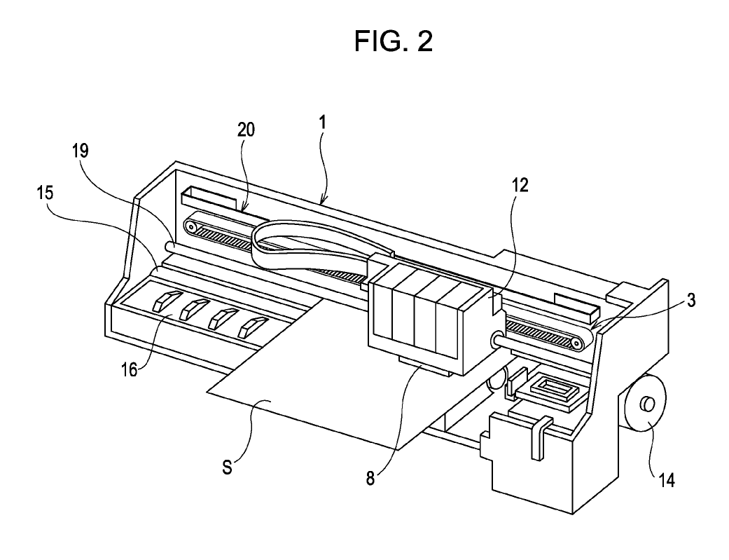

FIG. 1 is a block diagram illustrating the electrical configuration of a printer 1. Also, FIG. 2 is a perspective view illustrating the internal configuration of the printer 1.

The illustrated printer 1 ejects ink, which is one type of liquid, toward a recording medium S such as printer paper, cloth, or a resin film. The recording medium S is one type of a landing target which is a target in which liquid is ejected and landed. A computer CP is connected to the printer 1 as an external apparatus so as to be able to communicate with the printer 1. In order to make the printer 1 print an image, the computer CP transmits image data to the printer 1.

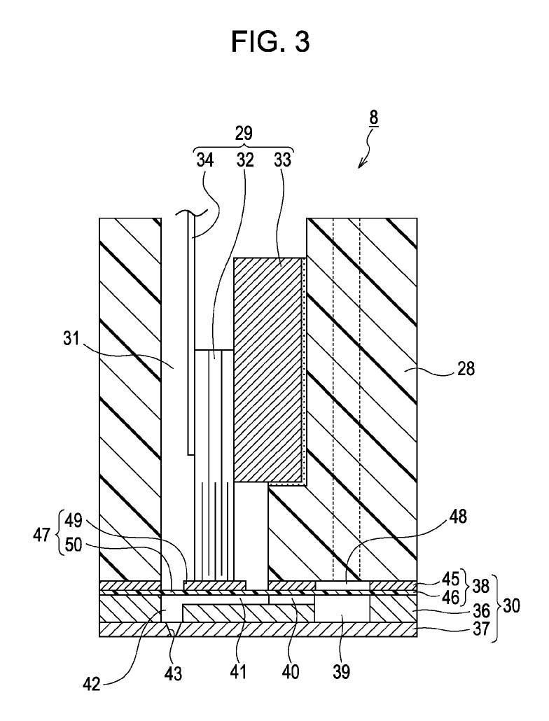

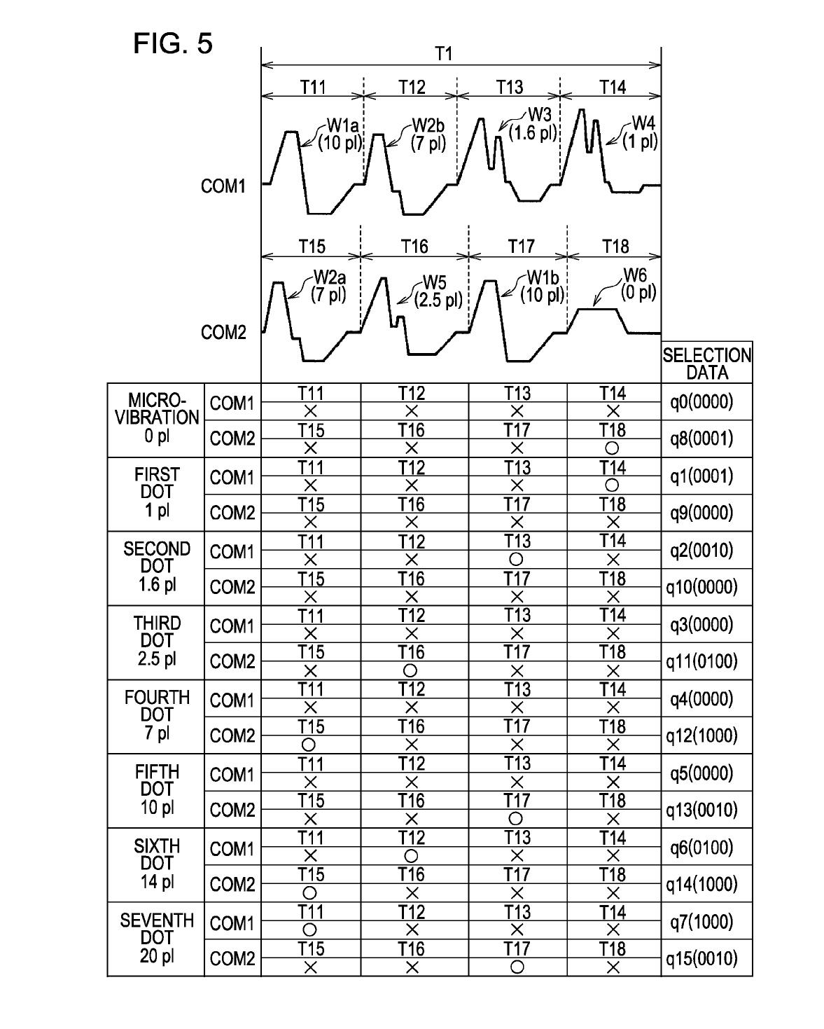

The printer 1 in this embodiment includes a transport mechanism 2, a carriage movement mechanism 3 (one type of a movement section), a driving signal generation circuit 4 (one type of a driving signal generation section), a head unit 5, a detector group 6, and a printer controller 7. The transport mechanism 2 transports the recording medium S in a transport direction. The carriage movement mechanism 3 moves a carriage, on which the head unit 5 is mounted, in a given moving direction (for example, along the length of the paper or a “paper-width direction”). The driving signal generation circuit 4 includes a DAC (Digital Analog Converter) (not shown). The driving signal generation circuit 4 generates an analog voltage signal on the basis of waveform data relating to the waveform of a driving signal sent from the printer controller 7. The driving signal generation circuit 4 also includes an amplifier circuit (not shown) that power-amplifies a voltage signal from the DAC, thereby generating driving signals COM1 and COM2 (collectively represented hereinafter as “COM”). The driving signal generation circuit 4 in this embodiment includes a first driving signal generation section 4a, which generates a first driving signal COM1, and a second driving signal generation section 4b, which generates a second driving signal COM2. These driving signals are applied to a piezoelectric vibrator 32 (refer to FIG. 3) of a recording head 8 at the time of a printing process on the recording medium S. A printing process is one type of recording process or ejection process. Each of the driving signals includes at least one or more driving pulses W in a unit period T1 that is a periodic time interval of the driving signal, as shown as one example in FIG. 5. In FIG. 5, each driving pulse W is for making the piezoelectric vibrator 32 carry out a given operation in order to eject ink of a liquid droplet shape from the recording head 8. In addition, the details of each of the driving signals COM1 and COM2 will be described below.

The head unit 5 includes the recording head 8 and a head control section 11. The recording head 8 is one type of a liquid ejecting head and ejects ink from a nozzle 43 (see FIG. 3) toward the recording medium S, thereby making the ink land in a given area (an area corresponding to a pixel that is a formation unit of an image or the like) of the recording medium S, thereby forming a dot. An image or the like is recorded on the recording medium S by arranging a plurality of dots in a matrix form. The head control section 11 controls the recording head 8 on the basis of a head control signal from the printer controller 7. In addition, the configuration of the recording head 8 will be described below. The detector group 6 is composed of a plurality of detectors which monitors the status of the printer 1. In the detector group 6, a temperature sensor (one type of a temperature detection section; not shown) which detects an environmental temperature of the inside of the printer is included. The temperature sensor is constituted by, for example, a thermistor and provided inside the recording head 8. The temperature sensor detects the temperature of the inside of the recording head 8 and outputs temperature information in the form of a detection signal to a CPU 25 of the printer controller 7.

The transport mechanism 2 is a mechanism for transporting the recording medium S in a direction (hereinafter referred to as a transport direction) perpendicular to a scanning direction of the recording head 8. The transport mechanism 2 includes a transport motor 14, a transport roller 15, and a platen 16. The transport roller 15 is a roller that transports the recording medium S up to a printable area above the platen 16, and is driven by the transport motor 14. The platen 16 supports the recording medium S during printing.

The printer controller 7 is a control unit for performing control of the printer. The printer controller 7 includes an interface section 24, the CPU 25, and a memory (one type of a storage section). The interface section 24 performs transmission and reception of data between the printer 1 and the computer CP external to the printer 1. The CPU 25 is an arithmetic processing device for performing control of the entire printer. The memory 26 includes a storage element, such as a RAM or an EEPROM having a secure area of memory for one or more programs executed by the CPU 25, and a working area of memory, or the like. The CPU 25 controls each unit in accordance with the one or more programs stored in the memory 26. Also, the printer controller 7 generates dot formation data SI indicating what size of a dot is formed at what position on the recording medium S, on the basis of the printing data from the computer CP, and transmits the dot formation data SI to the head control section 11. As will be described below, in one embodiment of the printer 1 recording can be performed with eight gradations with respect to one pixel, and the dot formation data SI is one type of pixel gradation data indicating any of these gradations. The head control section 11 generates selection data for selecting each driving pulse that is included in the driving signals COM1 and COM2, on the basis of the dot formation data SI from the printer controller 7, and then applies the driving signals to the piezoelectric element 32. Therefore, the printer controller 7 and the head control section 11 function as a selection control section. In addition, the details of the selection data will be described below.

As shown in FIG. 2, a carriage 12 that carries the recording head 8 is mounted in a state where it is supported on a guide rod 19 that extends in a main scanning direction. The carriage 12 is constituted so as to reciprocate in the main scanning direction perpendicular to the transport direction of the recording medium S along the guide rod 19 by an operation of the movement mechanism for carriage 3. A position in the main scanning direction of the carriage 12 is detected by a linear encoder 20 and a detection signal providing position information in the form of e.g., an encoder pulse is transmitted from the linear encoder 20 to the CPU 25 of the printer controller 7. The linear encoder 20 is one type of a position information output section and outputs as position information an encoder pulse according to a scanning position of the recording head 8 in the main scanning direction. Accordingly, the printer controller 7 can control a recording operation of the recording head 8 while recognizing the scanning position of the carriage 12, which carries the recording head 8, on the basis of an encoder pulse EP from the linear encoder 20. In addition, the printer 1 is configured so as to be able to perform a so-called “bi-directional” recording process in which the printer 1 records a character, an image, or the like on the recording medium S during both a forward movement, in which the carriage 12 moves from a home position toward an end portion (hereinafter referred to as a full-position) on the opposite side, and during a return movement, in which the carriage 12 returns from the full-position to the home position side.

The encoder pulse EP from the linear encoder 20 is input to the printer controller 7. The printer controller 7 generates a timing pulse PTS (Print Timing Signal) from the encoder pulse EP and performs transmission of the printing data, generation of the driving signal COM, or the like in synchronization with the timing pulse PTS. The driving signal generation circuit 4 outputs the driving signal COM at a timing based on the timing pulse PTS. Also, the printer controller 7 generates a timing signal such as a latch signal LAT on the basis of the timing pulse PTS and then outputs it to the recording head 8. The latch signal LAT is a signal that defines a start timing of a recording period. Therefore, it can be said that a unit period of the driving signal COM is a section which is defined by the latch signal LAT.

Next, the configuration of the recording head 8 will be described with reference to FIG. 3.

The recording head 8 includes a case 28, a vibrator unit 29 which is stored in the case 28, a flow path unit 30 which is joined to the bottom (leading end face) of the case 28, and the like. The case 28 is made of, for example, epoxy system resin and inside thereof, a storage hollow portion 31 for storing the vibrator unit 29 is formed. The vibrator unit 29 includes the piezoelectric vibrator 32 (a piezoelectric element) which functions as one type of a pressure generation section, a fixed plate 33, to which the piezoelectric vibrator 32 is joined, and a flexible cable 34 for supplying the driving signal or the like to the piezoelectric vibrator 32. The piezoelectric vibrator 32 is a piezoelectric vibrator of a longitudinal vibration mode (electric field transverse effect type) which is a lamination type made by carving a piezoelectric plate, in which a piezoelectric body layer and an electrode layer are alternately stacked, into a toothcomb shape and can extend or contract in a direction perpendicular to the lamination direction (an electric field direction).

The flow path unit 30 includes a nozzle plate 37 joined to a face of one side of a flow path substrate 36 and a vibration plate 38 joined to a face of the other side of the flow path substrate 36. At the flow path unit 30, a reservoir 39 (also called a common liquid chamber or a manifold), an ink supply port 40, a pressure chamber 41, a nozzle communication port 42, and a nozzle 43 are provided. A successive ink flow path corresponding to the nozzle 43 extends from the ink supply port 40 to the nozzle 43 through the pressure chamber 41 and the nozzle communication port 42.

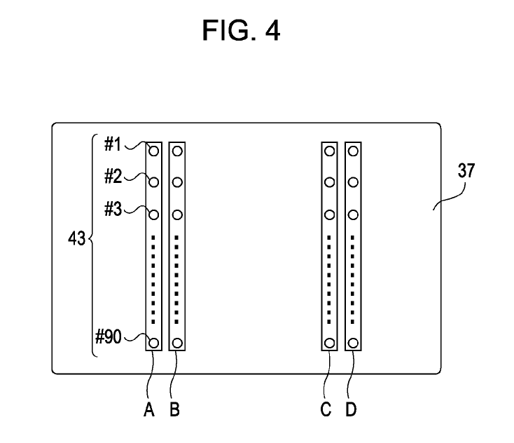

FIG. 4 is a plan view illustrating the configuration of the nozzle plate 37. In this view, a lateral direction is the main scanning direction (one type of a relative movement direction) in which the recording head 8 moves with respect to the recording medium S, and a longitudinal direction is the transport direction of the recording medium S, that is, a sub-scanning direction. The nozzle plate 37 is a member, in which a plurality (for example, 90) of nozzles 43 is perforated in a row along the sub-scanning direction at a pitch (for example, 180 dpi) corresponding to dot formation density. Moreover, four rows of nozzles A to D (one type of a nozzle group) are formed side by side along the main scanning direction. The nozzle plate 37 may be made of stainless steel, for example, or of a silicon single-crystal substrate.

The vibration plate 38 has a double structure in which an elastic body film 46 is laminated on the surface of a support plate 45. In this embodiment, the vibration plate 38 is made by using a composite plate material in which a stainless plate that is one type of a metal plate is used as the support plate 45 and a resin film as the elastic body film 46 is laminated on the surface of the support plate 45. At the vibration plate 38, a diaphragm portion 47, which changes the volume of the pressure chamber 41, is provided. Also, at the vibration plate 38, a compliance portion 48, which seals a portion of the reservoir 39, is provided.

The diaphragm portion 47 is made by partially removing the support plate 45 by etching or the like. That is, the diaphragm portion 47 is composed of an island portion 49, to which a leading end face of a free-end portion of the piezoelectric vibrator 32 is joined, and a thin-walled elastic portion 50 surrounding the island portion 49. The compliance portion 48 is made by removing the support plate 45 in an area facing the opening face of the reservoir 39 by etching or the like, as with the diaphragm portion 47. The compliance portion 48 functions as a damper, which absorbs pressure fluctuations of liquid stored in the reservoir 39.

Since the leading end face of the piezoelectric vibrator 32 is joined to the island portion 49, the volume of the pressure chamber 41 can be varied by extending and contracting the free-end portion of the piezoelectric vibrator 32. Pressure fluctuation occurs in the ink in the pressure chamber 41 in accordance with the volume variation. Then, the recording head 8 is made so as to eject an ink droplet from the nozzle 43 by using the pressure fluctuation.

FIG. 5 is a waveform diagram illustrating the different possible configurations of the driving signals, which are generated by the driving signal generation circuit 4, and a table showing a correspondence between each gradation of a pixel and the selection data for that gradation. The unit period T1, i.e., the periodic time interval of the driving signal, is equivalent to a time in which the nozzle 43 moves by a distance corresponding to the width of the pixel when the recording head 8 ejects ink while moving relative to the recording medium S. The unit period T1 may be set to be 100 μs, for example. Thus, for example, a repetition frequency of the driving signal is 10 kHz. In one embodiment, dots of seven different sizes may be formed for one pixel. Moreover, one dot may be composed of a plurality of small dots. Therefore, the printer 1 may express a total of eight gradations, including a non-recording gradation (i.e., a micro-vibration), in which a dot is not formed with respect to the pixel. For example, the printer 1 may form a first dot in which an amount of ink is 1 pl (ng), a second dot in which an amount of ink is 1.6 pl, a third dot in which an amount of ink is 2.5 pl, a fourth dot in which an amount of ink is 7 pl, a fifth dot in which an amount of ink is 10 pl, a sixth dot in which an amount of ink is 14 pl, and a seventh dot in which an amount of ink is 20 pl. Of these, each of the sixth dot and seventh dots is formed by sequentially selecting two ejection driving pulses in the same unit period and then applying each ejection driving pulse to the piezoelectric vibrator 32, thereby ejecting ink from the nozzle 43 twice in a unit period. In this manner, the printer 1 may form seven kinds of dots by using five kinds of ejection driving pulses. Also, since these different kinds of ejection driving pulses are divided and included in two driving signals COM1 and COM2, gradation properties may be improved without lengthening the unit period T1. In addition, a targeted or specified amount of ink is ejected from the nozzle 43 by using a corresponding driving pulse. Sometimes the actual amount ejected varies in accordance with the viscosity of the ink, a vibration state of a meniscus, or the like. Also, gradation properties are improved such that a fewer number of ink colors can be used. For example instead of using six or more ink colors (black, yellow, cyan, magenta, light cyan, and light magenta), the printer 1 may use only four ink colors (black, yellow, cyan, and magenta) without reduced granularity or resolution.

In the first driving signal COM1, the unit period T1 is divided into four periods, specifically, a period T11, a period T12, a period T13, and a period T14. In the period T11, a first ejection driving pulse W1a (one type of the largest driving pulse) is generated, in the period T12, a second ejection driving pulse W2b (one type of a first driving pulse in the invention) is generated, in the period T13, a third ejection driving pulse W3 (one type of another driving pulse) is generated, and in the period T14, a fourth ejection driving pulse W4 (one type of another driving pulse in the invention) is generated. Similarly, in the second driving signal COM2, the unit period T1 is divided into a period T15, a period T16, a period T17, and a period T18. In the period T15, a second ejection driving pulse W2a (one type of a second driving pulse in the invention) is generated, in the period T16, a fifth ejection driving pulse W5 (one type of another driving pulse) is generated, in the period T17, a first ejection driving pulse W1b (one type of the largest driving pulse) is generated, and in the period T18, a micro-vibration driving pulse W6 is generated.

The first ejection driving pulses W1a and W1b are ejection driving pulses designed so as to eject 10 pl of ink, which is the largest amount of ink that is ejected from the nozzle 43 at a time. The first ejection driving pulse W1b is used to form the fifth dot. Also, the combination of the first ejection driving pulses W1a and W1b is used to form the seventh dot. The second ejection driving pulses W2a and W2b are ejection driving pulses designed so as to eject 7 pl of ink, which is the second largest amount of ink next to the amount of ink ejected by each of the first ejection driving pulses W1a and W1b. The second ejection driving pulse W2a, which is generated before the second ejection driving pulse W2b in the unit period T1, is used to form the fourth dot. In this manner, by adopting a configuration in which the second ejection driving pulse W2a is used to form the fourth dot, a subsequent ink ejection corresponding to a subsequent unit period T1 does not occur until after as long a period of time as possible. As a result, a state of a meniscus may be stabilized as much as possible before a subsequent ink ejection.

Also, the combination of the second ejection driving pulses W2a and W2b is used to form the sixth dot. The amount of ink corresponding to the sixth dot is 14 pl, which is close to half of the sum of the amount of ink, 10 pl, corresponding to the fifth dot and the amount of ink, 20 pl, corresponding to the seventh dot. For this reason, a difference in amount of ink between the respective gradations is suppressed as much as possible, so that the second ejection driving pulses W2a and W2b contribute to improvement in granularity in an image. In addition, regarding the second ejection driving pulses W2a and W2b, the amount of ink ejected by using only a single one of the second ejection driving pulses is not limited to 7 pl and may be designed so as to be, for example, 8 pl so that the total amount of ink ejected by the combination of the second ejection driving pulses W2a and W2b is 16 pl. In short, the total amount of ink ejected by the combination of the second ejection driving pulses W2a and W2b may be any value that is close to the average of the amount of ink ejected by using only a single one of the first ejection driving pulses, which is the largest driving pulse, and the total amount of ink ejected by the combination of the first ejection driving pulses W1a and W1b. The details of the second ejection driving pulses W2a and W2b will be described below.

The third ejection driving pulse W3 is an ejection driving pulse for ejecting 1.6 pl of ink and is used to form the second dot. Also, the fourth ejection driving pulse W4 is an ejection driving pulse designed so as to eject 1 pl of ink, which is the least amount among the respective driving pulses and is used to form the first dot. The micro-vibration driving pulse W6 is a driving pulse for micro-vibrating a meniscus in the nozzle 43 to suppress thickening of the ink without causing ink to be ejected from the nozzle 43. The micro-vibration driving pulse W6 is selected in the case of non-recording in which a dot is not formed.

Each bit in a set of selection data q expresses whether or not the driving pulse of each period of a corresponding driving signal is selected. That is, in a case where the bit of a selection data set is “0”, the bit expresses that a corresponding driving pulse is not selected (that is, it is not applied to the piezoelectric vibrator 32), and in a case where the bit of a selection data set is “1”, the bit expresses that a corresponding driving pulse is selected (that is, it is applied to the piezoelectric vibrator 32). Alternatively, correspondence relationships between “0” and “1” and the selection and non-selection of a pulse may be reversed. Since each of the driving signals COM1 and COM2 in this embodiment is divided into four periods, a selection data set is composed of four bits of data. For one pixel's gradation, a total of two selection data sets, the selection data set for selecting the driving pulse of the first driving signal COM1 and the selection data set for selecting the driving pulse of the second driving signal COM2, are required for pulse selection control. In the example of FIGS. 5, q0 to q7 are the selection data sets corresponding to the first driving signal COM1 and q8 to q15 are the selection data sets corresponding to the second driving signal COM2. In addition, in this embodiment, since two or more driving pulses are not selected from the same driving signal in the same unit period T1, there are a total of four permissible permutations of selection data sets: “0000”, “0001”, “0010”, “0100”, and “1000”.

If the dot formation data SI expresses the “non-recording (0 pl) in which a dot is not formed at a pixel”, the head control section 11 outputs q0 as the selection data set corresponding to the first driving signal COM1 and outputs q8 as the selection data set corresponding to the second driving signal COM2. The selection data set q0 is “0000” and, therefore, none of the driving pulses of the first driving signal COM1 is selected. On the other hand, q8 is “0001” and, therefore, the micro-vibration driving pulse W6 of the period T18 of the second driving signal COM2 is selected and applied to the piezoelectric vibrator 32. Similarly, in a case where the dot formation data SI expresses the “first dot (1 pl)”, only the fourth ejection driving pulse W4 of the first driving signal COM1 is selected on the basis of the selection data set q1 (0001) and the selection data set q9 (0000). If the dot formation data SI expresses the “second dot (1.6 pl)”, only the third ejection driving pulse W3 of the first driving signal COM1 is selected on the basis of the selection data set q2 (0010) and the selection data set q10 (0000). If the dot formation data SI expresses the “third dot (2.5 pl)”, only the fifth ejection driving pulse W5 of the second driving signal COM2 is selected on the basis of the selection data set q3 (0000) and the selection data set q11 (0100). If the dot formation data SI expresses the “fourth dot (7 pl)”, only the second ejection driving pulse W2a of the second driving signal COM2 is selected on the basis of the selection data set q4 (0000) and the selection data set q12 (1000). If the dot formation data SI expresses the “fifth dot (10 pl)”, only the first ejection driving pulse W1b of the second driving signal COM2 is selected on the basis of the selection data set q5 (0000) and the selection data set q13 (0010).

If the dot formation data SI expresses the “sixth dot (14 pl)”, the second ejection driving pulse W2a of the second driving signal COM2 and the second ejection driving pulse W2b of the first driving signal COM1 are selected in this order on the basis of the selection data set q6 (0100) and the selection data set q14 (1000). Therefore, after the second ejection driving pulse W2a, which is generated in the first period T15 in the unit period T1 is applied to the piezoelectric vibrator 32, the second ejection driving pulse W2b, which is generated in the period T12 later than the second ejection driving pulse W2a in the unit period T1, is applied to the piezoelectric vibrator 32. As a result, within the same unit period, an ink droplet is consecutively ejected twice from a corresponding nozzle 43, and these ink droplets both land in a pixel area on the recording medium S, so that the sixth dot is formed. By such a configuration, it is possible to land a larger amount of ink than the maximum amount (in this embodiment, 10 pl) of ink that is obtained by a single ejection, in a single pixel area on the recording medium S.

Similarly, in a case where the dot formation data SI expresses the “seventh dot (20 pl)”, the first ejection driving pulse W1a of the first driving signal COM1 and the first ejection driving pulse W1b of the second driving signal COM2 are selected on the basis of the selection data set q7 (1000) and the selection data set q15 (0010). Therefore, after the first ejection driving pulse W1a, which is generated in the first period T11 in the unit period T1, is applied to the piezoelectric vibrator 32, the first ejection driving pulse W1b, which is generated in the period T17 later than the first ejection driving pulse W1a, is applied to the piezoelectric vibrator 32. As a result, within the unit period T1, an ink droplet is consecutively ejected twice from a corresponding nozzle 43, and these ink droplets both land in a pixel area on the recording medium S, so that the seventh dot is formed.

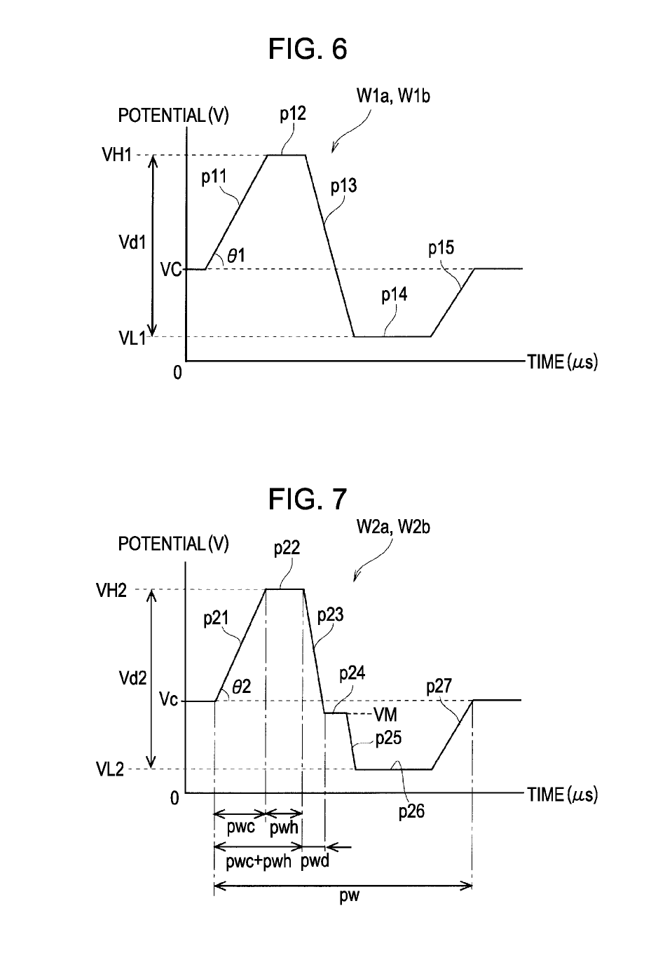

FIG. 6 is a waveform diagram illustrating the configuration of each of the first ejection driving pulses W1a and W1b.

As shown in FIG. 6, the first ejection driving pulse is composed of a preliminary expansion section p11, an expansion holding section p12, a contraction section p13, a contraction holding section p14, and a return expansion section p15. The preliminary expansion section p11 is a waveform element in which an electric potential changes (rises) at a constant positive gradient (θ1) (equivalent to a first polarity) from a reference electric potential VC up to a first expansion electric potential VH1, and the expansion holding section p12 is a waveform element that is constant at the first expansion electric potential VH1, which is a termination electric potential of the preliminary expansion section p11. Also, the contraction section p13 is a waveform element in which an electric potential changes (falls) at a constant negative gradient (equivalent to a second polarity) from the first expansion electric potential VH1 down to a first contraction electric potential VL1. The contraction holding section p14 is a waveform element that is constant at the first contraction electric potential VL1, and the return expansion section p15 is a waveform element in which an electric potential returns from the first contraction electric potential VL1 up to the reference electric potential VC.

If the first ejection driving pulse W1a or W1b configured as described above is applied to the piezoelectric vibrator 32, first, the piezoelectric vibrator 32 contracts in the longitudinal direction of the element by the preliminary expansion section p11 and accordingly, the pressure chamber 41 expands from a reference volume corresponding to the reference electric potential VC up to an expanded volume corresponding to the first expansion electric potential VH1. Because of this expansion, a meniscus in the nozzle 43 is greatly drawn to the pressure chamber 41 side and also ink is supplied from the reservoir 39 side into the pressure chamber 41 through the ink supply port 40. Then, the expanded state of the pressure chamber is maintained over a supply period of the expansion holding section p12.

After the expanded state is maintained by the expansion holding section p12, the contraction section p13 is applied to the piezoelectric vibrator 32 and accordingly, the piezoelectric vibrator 32 extends. As a result, the pressure chamber 41 is contracted from the expanded volume up to a contracted volume corresponding to the first contraction electric potential VL1. As a result, ink in the pressure chamber 41 is pressurized, so that the central portion of the meniscus in the nozzle 43 is extruded to the ejection side and the extruded portion is extended like a liquid column. Subsequently, the contracted state of the pressure chamber 41 is maintained for a given length of time by the contraction holding section p14. In this period, the meniscus and the liquid column are separated from each other, and the separated portion is ejected as an ink droplet from the nozzle 43, thereby flying toward the recording medium S. The return expansion section p15 is applied to the piezoelectric vibrator 32 to substantially coincide with a rise in ink pressure in the pressure chamber 41, which was reduced due to the ejection of ink. By the application of the return expansion section p15, the pressure chamber 41 expands and returns up to a normal volume, and pressure fluctuation (residual vibration) of ink in the pressure chamber 41 is absorbed, that is, dampened.

Since each of the first ejection driving pulses W1a and W1b is designed to maximize the amount of ink that is ejected at once, the first ejection driving pulses are preferably used when performing so-called “solid coating printing” which fills out a given area on the recording medium S. Moreover, complex vibrations are not likely to develop when the first ejection driving pulses W1a and W1b are used because these driving pulses have the simplest and, consequently, cause the most gentle pressure changes out of all the driving pulses in the driving signals COM1 and COM2 (excepting the micro-vibration driving pulse W6). Therefore, residual vibration of the meniscus after ink is ejected using the first ejection driving pulse is also easily dampened by the return expansion section p15. Also, since the first ejection driving pulses W1a and W1b cause ejection of ink droplets having a greater weight, the ink droplets are not as likely to be affected by vibration in the meniscus. Accordingly, the first ejection driving pulses W1a and W1b, in which the amount of ink which is ejected at a time is greatest, 10 pl (10 ng), are suitable for higher-frequency driving.

The time interval between the first ejection driving pulses W1a and W1b in the unit period T1 is preferably half of the unit period T1 (T1/2) or a value as close to half as possible. The time interval between the first ejection driving pulses W1a and W1b is widened as far as possible to stabilize ink ejection because the first ejection driving pulses W1a and W1b are sometimes used in higher-frequency driving applications, e.g., as in the above-mentioned solid coating printing. That is, the wider the time interval between the pulses, the less influence is exerted by a residual vibration after ink is ejected by the first ejection driving pulse W1a, which is first generated in the unit period T1, on the ejection of ink by the first ejection driving pulse W1b, which is generated later. Also, since the first ejection driving pulses W1a and W1b are designed so as to maximize the amount of ejected ink, if a dot is formed at a biased position of a pixel area when forming the seventh dot, a bias is more conspicuous than for a smaller dot. Therefore, the time interval between dots that are formed on a pixel area is preferably widened by widening the time interval between the first ejection driving pulses W1a and W1b as far as possible.

FIG. 7 is a waveform diagram illustrating the configuration of each of the second ejection driving pulses W2a and W2b.

As shown in FIG. 7, the second ejection driving pulse is composed of a preliminary expansion section p21 (equivalent to a first change element), an expansion holding section p22 (equivalent to a maintaining element), a first contraction section p23 (equivalent to a second change element), an intermediate holding section p24, a second contraction section p25, a contraction holding section p26, and a return expansion section p27. The preliminary expansion section p21 is a waveform element in which an electric potential changes at a steeper positive gradient (θ2>θ1) than the gradient of the preliminary expansion section p11 of the first ejection driving pulse, from the reference electric potential VC up to a second expansion electric potential VH2. The expansion holding section p22 is a waveform element that is constant at the second expansion electric potential VH2, which is a termination electric potential of the preliminary expansion section p21. Also, the first contraction section p23 is a waveform element in which an electric potential decreases from the second expansion electric potential VH2 down to an intermediate electric potential VM, and the intermediate holding section p24 is a waveform element that is constant at the intermediate electric potential VM. Further, the second contraction section p25 is a waveform element in which an electric potential changes (falls) at a constant negative gradient from the intermediate electric potential VM down to a second contraction electric potential VL2, the contraction holding section p26 is a waveform element that is constant at the second contraction electric potential VL2, and the return expansion section p27 is a waveform element in which an electric potential returns from the second contraction electric potential VL2 up to the reference electric potential VC.

If the second ejection driving pulse W2a or W2b configured as described above is applied to the piezoelectric vibrator 32, first, the piezoelectric vibrator 32 contracts in the longitudinal direction of the element by the preliminary expansion section p21 and accordingly, the pressure chamber 41 expands from a reference volume corresponding to the reference electric potential VC up to an expanded volume corresponding to the second expansion electric potential VH2 (a first change process). Due to this expansion, the meniscus in the nozzle 43 is greatly drawn to the pressure chamber 41 side and also ink is supplied from the reservoir 39 side into the pressure chamber 41 through the ink supply port 40. Since in the preliminary expansion section p21, an electric potential changes at a steeper gradient than the gradient of the preliminary expansion section p11 of the first ejection driving pulse, the meniscus is more rapidly drawn in. Moreover, the central portion of the meniscus, which is located relatively far from the inner circumferential surface of the corresponding nozzle, moves faster following a change in pressure than an outer portion (a boundary layer), which is located closer to the inner circumferential surface of the nozzle than the central portion, and is therefore slowed down more by viscosity following the change in pressure. Accordingly, in response to the first ejection driving pulse, the entire meniscus is largely drawn in by the preliminary expansion section p11, whereas in response to the second ejection driving pulse, mainly the central portion of the meniscus tends to be largely drawn in by the preliminary expansion section p21. Therefore, a liquid column caused by the preliminary expansion section p21 of the waveform is made small, which will be described below. Then, the expanded state of the pressure chamber 41 is maintained over a supply period of the expansion holding section p22 (a holding process).

After the expanded state is maintained by the expansion holding section p22, the first contraction section p23 is applied to the piezoelectric vibrator 32 and accordingly, the piezoelectric vibrator 32 extends. As a result, the pressure chamber 41 is contracted from the expanded volume up to an intermediate volume corresponding to the intermediate electric potential VM (a second change process). Accordingly, ink in the pressure chamber 41 is pressurized, so that the central portion of the meniscus in the nozzle 43 is extruded to the ejection side and the extruded portion is extended like a liquid column. Subsequently, the intermediate holding section p24 is supplied, so that the intermediate volume is maintained only for a small amount of time (a maintaining process). As a result, the extension of the piezoelectric vibrator 32 is temporarily stopped. In this period, since ink in the pressure chamber 41 is not pressurized, stretching of the liquid column is suppressed to a corresponding extent. Accordingly, the size of the liquid column is smaller than when the first ejection driving pulse is applied, which contracts the pressure chamber 41 up to a contracted volume at once without stopping on the way.

After the holding by the intermediate holding section p24, the piezoelectric vibrator 32 is quickly extended by the second contraction section p25, so that the volume of the pressure chamber 41 is pressurized from the intermediate volume up to a contracted volume (a third change process). As a result, the entire meniscus is rapidly extruded in an ejection direction, so that a back end portion of the liquid column is accelerated. Then, the meniscus and the liquid column are separated from each other, and the separated portion is ejected as an ink droplet from the nozzle 43, thereby flying toward the recording medium S. After the second contraction section p25, the contracted state of the pressure chamber 41 is maintained for a given length of time by the contraction holding section p26. The return expansion section p27 is applied to the piezoelectric vibrator 32 to substantially coincide with a rise in ink pressure in the pressure chamber 41, which was reduced due to the ejection of ink. Due to the application of the return expansion section p27, the pressure chamber 41 expands and returns up to a normal volume, and pressure fluctuation of ink in the pressure chamber 41 is dampened.

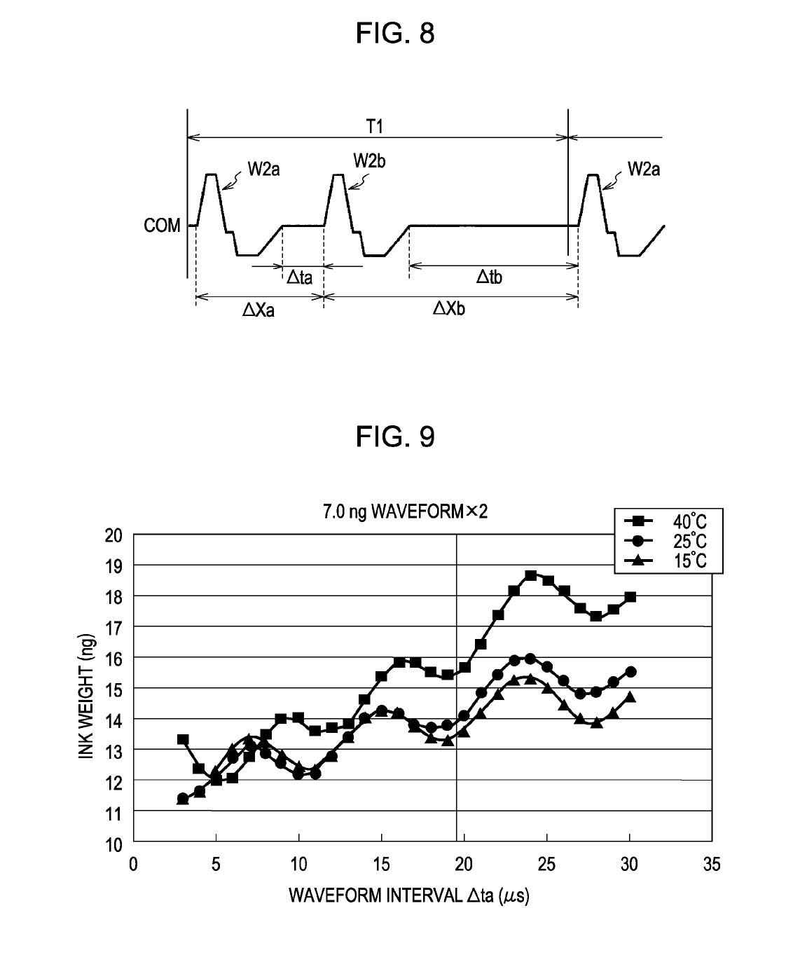

FIG. 8 shows a waveform pattern in a case where the second ejection driving pulses W2a and W2b are sequentially selected in the unit period T1, whereby ink is ejected in twice from the nozzle 43, thereby forming the sixth dot on the recording medium S. The second ejection driving pulse W2 in this embodiment is designed such that 7 pl of ink is ejected from the nozzle 43 by applying a single one of the second ejection driving pulses to the piezoelectric vibrator 32. Consequently, the total amount of ink that is ejected from the nozzle 43 by the combination of the second ejection driving pulses W2a and W2b when forming the sixth dot is preferably 14 pl. However, the second ejection driving pulse is set such that the electric potential gradient θ2 of the preliminary expansion section p21 is steeper than that of the waveform of the first ejection driving pulse, and accordingly, the drawing-in speed of the meniscus becomes higher. Therefore, residual vibration after ink is ejected by using the second ejection driving pulse is larger than for the first ejection driving pulse. Thus, the behavior of the meniscus in the nozzle 43 is disordered by the residual vibration, which can adversely affect performance of an ejection operation of a subsequent ink droplet. Thus, the total amount of ink that is ejected from the nozzle 43 by the combination of the second ejection driving pulses W2a and W2b may not be 14 pl due to the influence of the residual vibration. Therefore, in consideration of the residual vibration after ink is ejected by the second ejection driving pulse W2a, which is first generated in the same unit period T1, it is necessary to determine a temporal position of the second ejection driving pulse W2b, which is generated later than the second ejection driving pulse W2a. That is, an interval Ata between the second ejection driving pulses W2a and W2b is preferably determined to result in 14 pl of ink (i.e., twice the amount ejected by use of only one of the second ejection driving pulses) being ejected from the nozzle 43 by the combination of the second ejection driving pulses W2a and W2b. From the viewpoint of suppressing the adverse effect of the residual vibration due to the ejection of ink by the second ejection driving pulse W2a, which is first generated, on the ejection of ink by the second ejection driving pulse W2b, which is generated later, Δta is preferably made as wide as possible. However, if Δta is simply widened, according to a phase of the residual vibration, the desired total amount of ink might not be obtained. Also, the inclusion of different kinds of ejection driving pulses and the micro-vibration driving pulse in the driving signal and the interest in making the unit period T1 as short as possible act as constraints in the setting of the interval Δta. Therefore, an optimal interval Δta is selected within a range permitted by such constraints.

FIG. 9 is a graph showing, in the absence of a countermeasure of the invention, a total amount of ink that is ejected from the nozzle 43 by the combination of the second ejection driving pulses W2a and W2b versus the interval Δta between the second ejection driving pulses W2a and W2b at various different environmental temperatures. The amount of ink ejected is shown for temperatures of 15° C., 25° C., and 40° C., as detected by a temperature sensor. When the temperature is determined to be a reference temperature, such as 25° C., the interval Δta between the pulses is set such that the total amount of ejected ink is a value as close to 14 ng (14 pl) as possible (for example, within a range of ±0.1). More specifically, the Δta is set to be equal to 19 μs, as indicated by the vertical line at 19 μs on the graph.

As demonstrated by the graph of FIG. 9, if an environmental temperature (i.e., a temperature of the inside of the printer, in particular, a temperature in the vicinity of the nozzle 43 of the recording head 8) changes, the viscosity of ink changes in accordance with the change in temperature. Specifically, at a temperature higher than the reference temperature (for example, at 40° C.), the viscosity of ink becomes lower than that at the reference temperature. Therefore, in the absence of any countermeasures, the total amount of ink ejected from the nozzle 43 when the combination of the second ejection driving pulses W2a and W2b is applied is larger than the amount ejected at the reference temperature. In the example of FIG. 9, the total amount of ink ejected at 40° C. is 15.5 ng (+11%). Conversely, at a temperature lower than the reference temperature (for example, at 15° C.), since the viscosity of ink becomes higher than at the reference temperature, the total amount of ink ejected from the nozzle 43 when the combination of the second ejection driving pulses W2a and W2b is applied is lower than the amount ejected at the reference temperature. In the example of FIG. 9, the total amount of ink ejected at 15° C. is 13.5 ng (−4%).

Therefore, the printer controller 7 and the driving signal generation circuit 4 function as a waveform correction section, thereby correcting the waveform of any one of the second ejection driving pulses W2a and W2b on the basis of a detected temperature from the temperature sensor and performing adjustment such that the total amount of ink that is ejected by the combination of the second ejection driving pulses W2a and W2b becomes a value as close to 14 ng as possible regardless of an environmental temperature. Specifically, the waveform of the second ejection driving pulse W2b which is selected only in combination with the second ejection driving pulse W2a when forming the sixth dot, is corrected in accordance with the detected temperature of the temperature sensor. Generally speaking, a waveform correction may be carried out according to two methods: (1) adjusting a generation duration of a waveform element (i.e., a time from the beginning to the end of a waveform element) constituting the second ejection driving pulse W2b, and (2) adjusting a driving voltage Vd2 (i.e., a difference in electric potential between the second expansion electric potential VH2 and the second contraction electric potential VL2). In addition, the correction of the second ejection driving pulse W2b may be performed with reference to the waveform duration and driving voltage parameters of the waveform of the second ejection driving pulse W2a as standard parameters. For example, the waveform of the second ejection driving pulse W2b at the reference temperature may be set to be equal to the waveform of the second ejection driving pulse W2a.

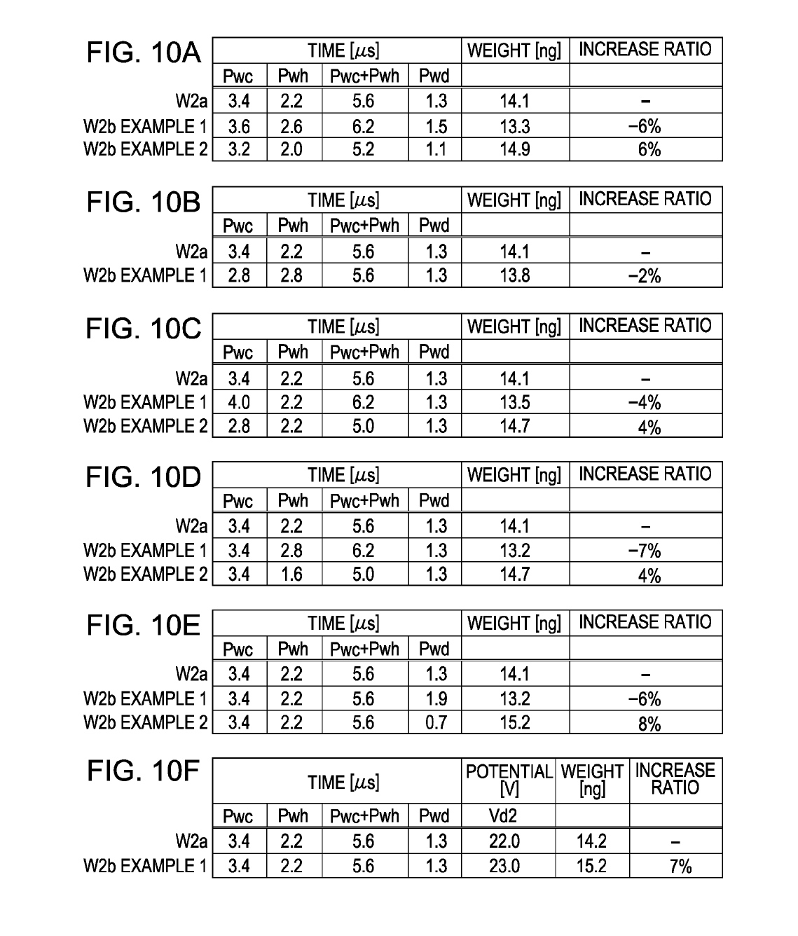

FIGS. 10A to 10F are tables showing specific examples of the correction of the waveform of the second ejection driving pulse W2b. In addition, the “increase ratio” column in the tables denotes the ratio of the amount (that is, the total amount) of ink that is obtained when ink is ejected by the combination of the second ejection driving pulses W2a and W2b after waveform correction versus the amount of ink that is obtained when ink has been ejected by the combination of the second ejection driving pulses W2a and W2b before waveform correction (i.e., when the second ejection driving pulse W2b has the same waveform as that of the second ejection driving pulse W2a), which is 14.1 ng, hereinafter referred to as a target total amount. In addition, all of the respective ink weights that are shown in the tables are values measured at the reference temperature. Also, the interval Ata between the second ejection driving pulses W2a and W2b is a value at which the amount of ink that is obtained when ink is ejected by the combination of both pulses at the reference temperature is 14.1 ng, and is constant. FIGS. 10A to 10F respectively correspond to the correction methods (A) through (F), which will be described below.

First, methods of adjusting the duration of a waveform element will be described.

The general method of adjusting the duration of a waveform element includes the following five specific methods. In addition, in all five methods, the driving voltage Vd2 is constant.

According to method (A), a duration Pwc of the preliminary expansion section p21, a duration Pwh of the expansion holding section p22, and a duration Pwd of the first contraction section p23 are respectively changed by the same correction amount.

According to method (B), the ratio of the duration Pwc of the preliminary expansion section p21 and the duration Pwh of the expansion holding section p22 is changed without changing the sum (Pwc+Pwh) of the duration Pwc of the preliminary expansion section p21 and the duration Pwh of the expansion holding section p22.

According to method (C), only the duration Pwc of the preliminary expansion section p21 is changed.

According to method (D), only the duration Pwh of the expansion holding section p22 is changed.

According to method (E), only the duration Pwd of the first contraction section p23 is changed.

Regarding the above method (A), with respect to basic parameters (Pwc=3.4, Pwh=2.2, Pwd=1.3, and Pwc+Pwh=5.6) of the waveform of the second ejection driving pulse W2a, in an example 1 of FIG. 10A, correction is made such that the Pwc and the Pwd parameters of the second ejection driving pulse W2b become respectively longer by 0.2 μs and the Pwh parameter becomes longer by 0.4 μs. Accordingly, the entire duration of the second ejection driving pulse W2b becomes longer by 0.8 μs (Pwc+Pwh increases by 0.6 μs). In this example, the amount of ink that is obtained when ink is ejected by the combination of the second ejection driving pulses W2a and W2b after waveform correction is 13.3 ng, representing a decrease of 6% compared to the target total amount. Also, in an example 2 of FIG. 10A, correction is made such that the Pwc, the Pwh, and the Pwd parameters of the second ejection driving pulse W2b respectively become shorter by 0.2 μs. Accordingly, the entire duration of the second ejection driving pulse W2b becomes shorter by 0.6 μs (Pwc+Pwh becomes shorter by 0.4 μs). In this example, the amount of ink that is obtained when ink is ejected by the combination of the second ejection driving pulses W2a and W2b after waveform correction is 14.9 ng, representing an increase of 6% compared to the target total amount. Thus, if the Pwc, the Pwh, and the Pwd parameters have been respectively increased to be higher than the standards, since a change in electric potential becomes gentle, the amount of ejected ink tends to decrease. Conversely, if the Pwc, the Pwh, and the Pwd parameters have been respectively decreased to be lower than the standards, since a change in electric potential becomes steeper, the amount of ejected ink tends to increase.

Regarding the above method (B), in an example 1 of FIG. 10B, correction is made such that the ratio of the Pwc and the Pwh parameters is changed while the sum (Pwc+Pwh) of the Pwc and the Pwh parameters of the second ejection driving pulse W2b is maintained at 5.6 μs. More specifically, the ratio of the Pwh parameter to the Pwc parameter in the second ejection driving pulse W2a is 0.65, whereas the ratio of the Pwh parameter to the Pwc parameter in the second ejection driving pulse W2b after waveform correction is 1. If correction has been made in this manner, the amount of ink that is obtained when ink is ejected by the combination of the second ejection driving pulses W2a and W2b after waveform correction is 13.8 ng, representing a decrease of 2% compared to the target total amount.

Regarding the above method (C), in an example 1 of FIG. 10C, correction is made such that the Pwc parameter of the second ejection driving pulse W2b becomes longer by 0.6 μs. In this case, the amount of ink that is obtained when ink is ejected by the combination of the second ejection driving pulses W2a and W2b after waveform correction is 13.5 ng, representing a decrease of 4% compared to the target total amount. Also, in an example 2 of FIG. 10C, correction is made such that the Pwc parameter of the second ejection driving pulse W2b becomes shorter by 0.6 μs. In this case, the amount of ink that is obtained when ink is ejected by the combination of the second ejection driving pulses W2a and W2b after waveform correction is 14.7 ng, representing an increase of 4% compared to the target total amount. In this manner, if the Pwc parameter has been increased to be higher than the standard, since a change in electric potential becomes gentler, an amount of ejected ink tends to decrease. Conversely, if the Pwc parameter has been lowered to be lower than the standard, since a change in electric potential becomes steeper, an amount of ejected ink tends to increase.

Regarding the above method (D), in an example 1 of FIG. 10D, correction is made such that the Pwh parameter of the second ejection driving pulse W2b becomes longer by 0.6 μs. In this case, the amount of ink that is obtained when ink is ejected by the combination of the second ejection driving pulses W2a and W2b after waveform correction is 13.2 ng, representing a decrease of 7% compared to the target total amount. Also, in an example 2 of FIG. 10D, correction is made such that the Pwh parameter of the second ejection driving pulse W2b becomes shorter by 0.6 μs. In this case, the amount of ink that is obtained when ink is ejected by the combination of the second ejection driving pulses W2a and W2b after waveform correction is 14.7 ng, representing an increase of 4% compared to the target total amount. In this manner, if the Pwh parameter has been increased, since a timing of when the first contraction section p23 is applied to the piezoelectric vibrator 32 after the preliminary expansion section p21 is applied to the piezoelectric vibrator 32 is changed, a vibration state (amplitude and phase) of the meniscus at the timing of the first contraction section p23 differs and accordingly, the amount of ink changes.

Regarding the above method (E), in an example 1 of FIG. 10E, correction is made such that the Pwd parameter of the second ejection driving pulse W2b becomes longer by 0.6 μs than the standard. In this case, the amount of ink that is obtained when ink is ejected by the combination of the second ejection driving pulses W2a and W2b after waveform correction decreases by 6% compared to the target total amount. Also, in an example 2 of FIG. 10E, correction is made such that the Pwd parameter of the second ejection driving pulse W2b becomes shorter by 0.6 μs than the standard. In this case, the amount of ink that is obtained when ink is ejected by the combination of the second ejection driving pulses W2a and W2b after correction increases by 8% compared to the target total amount. In this manner, since in example 1 the longer the Pwd parameter becomes compared to the standard, the gentler a change in electric potential becomes, and an amount of ejected ink tends to decrease. Conversely, in example 2, since the shorter the Pwd parameter becomes compared to the standard, the steeper a change in electric potential becomes, and the amount of ejected ink tends to increase.

Next, the above method (F) will be described, in which the driving voltage Vd2 (i.e., a difference in electric potential between the second expansion electric potential VH2 and the second contraction electric potential VL2) is adjusted. In this case, the duration of each waveform element is the standard value and is constant. As shown in an example 1 of FIG. 10F, in a case where the driving voltage Vd2 of the second ejection driving pulse W2b has been increased by 1 V from 22 V, which is the reference value, to 23 V, the amount of ink that is obtained when ink is ejected by the combination of the second ejection driving pulses W2a and W2b after waveform correction increases by 7% compared to the target total amount. In this manner, the higher the driving voltage Vd becomes compared to the standard, the more an amount of ejected ink increases. Also, although it is not illustrated, the lower the driving voltage Vd becomes compared to the standard, the more an amount of ejected ink decreases.

The printer controller 7 and the driving signal generation circuit 4 may correct the waveform of the second ejection driving pulse W2b by any of the methods of the above (A) through (F) on the basis of a detected temperature from the temperature sensor. Regarding the correction amounts of the parameters of the second ejection driving pulse W2b with respect to an environmental temperature, tables correlating the temperature with the appropriate correction amounts is stored in the memory 26, or the like, in advance. Then, the printer controller 7 corrects the waveform of the second ejection driving pulse W2b by the correction amount corresponding to the detected temperature with reference to the tables stored in the memory 26. In addition, it is also possible to use a calculating formula that calculates a correction amount from the detected temperature, thereby eliminating reliance on tables correlating the detected temperature with the correction amounts. In this manner, by performing correction according to an environmental temperature, the total amount of ink that is ejected by the combination of the second ejection driving pulses W2a and W2b is brought close to the target total amount regardless of an environmental temperature. As a result, variation in the size or the position of the sixth dot that is formed on the recording medium S, according to an environmental temperature is suppressed. Accordingly, granularity of an image or the like that is recorded on the recording medium S is improved, so that the lowering of image quality is prevented.

Also, since only the waveform of the second ejection driving pulse W2b of one side among the second ejection driving pulses W2a and W2b is corrected, that is, since correction is not performed with respect to the second ejection driving pulse W2a, the amount of ink ejected from the nozzle by selecting only the second ejection driving pulse W2a in the unit period T1 and then applying it to the piezoelectric vibrator 32 (when forming the fourth dot) is prevented from being unnecessarily varied. Also, a correction process or a circuit configuration is simplified since correction of only the first driving signals COM1 of the two driving signals COM1 and COM2 is required and correction of the second driving signals COM2 is not required.

According to another embodiment, only the waveform of the second ejection driving pulse W2a among the second ejection driving pulses W2a and W2b is corrected in accordance with an environmental temperature and correction is not performed with respect to the second ejection driving pulse W2b. Also in this embodiment, similar to the above-described embodiment, it is possible to bring the total amount of ink that is ejecting by the combination of the second ejection driving pulses W2a and W2b close to the target total amount regardless of environmental temperature.

In addition, the invention is not to be limited to each embodiment described above and various modifications can be made without departing from the scope of the present invention as defined in the claims.

For example, in the above-described embodiment, as one example of the ejection driving pulse in the invention, the ejection driving pulse illustrated in FIG. 5 has been described. However, the shape of the ejection driving pulse or the disposition of each ejection driving pulse in the driving signal is not limited to the shape or disposition illustrated.

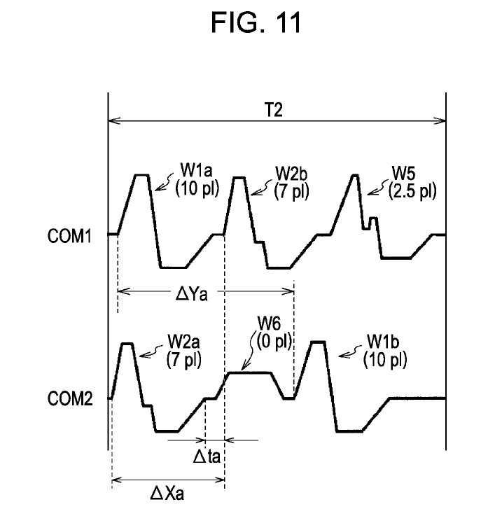

FIG. 11 is a waveform diagram illustrating the configurations of the driving signals COM1 and COM2 according to another embodiment of the invention. In FIG. 11, where a driving pulse has the same waveform as that of a corresponding driving pulse in the first embodiment described above, the same reference numeral as that of a corresponding driving pulse is applied.

In the driving signals of this alternative embodiment, the kinds of ejection driving pulses are reduced as compared to the driving signals COM1 and COM2 illustrated in FIG. 5. For example, in the first embodiment described above, one pixel can be expressed with eight gradations by forming dots of seven different sizes with use of six kinds of driving pulses including the micro-vibration pulse W6, whereas in this alternative embodiment, one pixel can be expressed with six gradations by forming dots of five different sizes with use of four kinds of driving pulses including the micro-vibration pulse W6. Also in this alternative embodiment, by correcting the waveform of the second ejection driving pulse W2b by any of the above methods (A) through (F) on the basis of the detected temperature from the temperature sensor, the total amount of ink that is ejected by the combination of the second ejection driving pulses W2a and W2b is brought close to the target total amount regardless of an environmental temperature. As a result, variation in the size or the position of the sixth dot, which is formed on the recording medium S, with respect to an environmental temperature is suppressed. In addition, with respect to other configurations, since they are the same as those in the first embodiment described above, an explanation thereof is omitted.

Also, in each embodiment described above, a configuration is illustrated in which ink is ejected while moving the recording head 8 with respect to the recording medium S. However, it is not limited thereto. For example, ink may be ejected while moving the recording medium S with respect to the recording head 8 in a state where the position of the recording head 8 is fixed. In short, principles of the invention can be applied to any embodiment in which ink is ejected onto the recording medium S while the recording head 8 and the recording medium S move relative to each other.

Also, in the above-described embodiments, the piezoelectric vibrator 32 of a so-called longitudinal vibration type has been illustrated as an example pressure generation section. However, it is not limited thereto. For example, a piezoelectric vibrator of a so-called flexural vibration type may also be used. If the piezoelectric vibrator is a flexural vibration type, the driving pulses W illustrated in the above-described embodiments, electric potential changes will be will reversed in the up-down direction.

Further, the pressure generation section is not limited to the piezoelectric vibrator. Instead, various other pressure generation sections, such as a heat generation element, which generates air bubbles in a pressure chamber, or an electrostatic actuator, which changes the volume of a pressure chamber by using an electrostatic force, may be used.

The ink jet type printer 1 described above is only one type of liquid ejecting apparatus. For example, principles of the invention can also be applied to a liquid ejecting apparatus that performs ejection of liquid by using a plurality of ejection driving pulses. Principles of the invention can also be applied to, for example, a display manufacturing apparatus that manufactures a color filter of a liquid crystal display or the like, an electrode manufacturing apparatus that forms an electrode of an organic EL (Electro Luminescence) display, an FED (a surface-emitting display), or the like, a chip manufacturing apparatus that manufactures a biochip (a biochemical element), or a micropipette that supplies a very small amount of sample solution in a precise amount.

What is claimed is:

1. A liquid ejecting apparatus comprising:
a liquid ejecting head configured to eject liquid from a nozzle in response to pressure from a pressure generation section;
a driving signal generation section configured to generate a plurality of driving signals, each of the driving signals including a plurality of driving pulses repeated in periodic time intervals, the driving pulses being configured to control an amount of pressure generated by the pressure generating section;
a selection control section configured to apply selected ones of the driving pulses included in the driving signals to the pressure generation section;
a temperature detection section configured to detect a temperature of the inside of the liquid ejecting apparatus; and
a waveform correction section configured to control the driving signal generation section to correct a waveform of one of a first driving pulse of a first one of the driving signals and a second driving pulse of a second one of the driving signals, the second driving pulse preceding but occurring within the same periodic time interval as the first driving pulse,
wherein the waveform correction section corrects the waveform of one of the first and second driving pulses based on the temperature that is detected by the temperature detection section.

2. The liquid ejecting apparatus according to claim 1, wherein each of the waveforms of the first and second driving pulses includes at least a first change portion in which an electric potential changes to a first polarity, a maintaining portion that maintains a final electric potential of the first change portion for a predetermined length of time, and a second change portion in which an electric potential changes from the final electric potential of the maintaining portion to a second polarity opposite to the first polarity, and
wherein the waveform correction section controls the driving signal generation section to correct the waveform by changing a duration of at least one of the first change portion, the maintaining portion, and the second change portion of the corrected waveform.

3. The liquid ejecting apparatus according to claim 1, wherein the waveform correction section controls the driving signal generation section to correct the waveform by changing an amplitude of the corrected waveform.

4. The liquid ejecting apparatus according to claim 1, wherein the first driving pulse is a driving pulse that is selected in combination with the second driving pulse by the selection control section, and
wherein the waveform correction section controls the driving signal generation section to correct the waveform of the second driving pulse based on the temperature that is detected by the temperature detection section.

5. The liquid ejecting apparatus according to claim 1, wherein each of the first and second driving signals includes in each of the periodic time intervals a largest driving pulse that causes a larger amount of pressure to be generated by the pressure generation section than either of the first and second driving pulses taken individually, wherein each of the first and second driving signals further includes, in each of the periodic time intervals, one or more other driving pulses, each of which causes a smaller amount of pressure to be generated by the pressure generation section than either of the first and second driving pulses taken individually,
wherein an interval between generation of the largest driving pulse of the first driving signal and the largest driving pulse of the second driving signal in the periodic time interval is closer to half of the periodic time interval than an interval between generation of the first driving pulse and the second driving pulse,
wherein the interval between generation of the first driving pulse and the second driving pulse in the periodic time interval is shorter than the interval between generation of the largest driving pulses in the periodic time interval, and
wherein another driving pulse or one of the largest driving pulses is generated after both the first driving pulse and the second driving pulse in the periodic time interval.

6. A method of controlling a liquid ejecting apparatus that includes a liquid ejecting head configured to eject liquid from a nozzle in response to pressure from a pressure generation section, the method comprising:
generating a plurality of driving signals, each of the driving signals including a plurality of driving pulses repeated in periodic time intervals, the driving pulses being configured to control an amount of pressure generated by the pressure generating section;
applying selected ones of the driving pulses included in the driving signals to the pressure generation section;
detecting a temperature of the inside of the liquid ejecting apparatus;
correcting a waveform of one of a first driving pulse of a first one of the driving signals and a second driving pulse of a second one of the driving signals based on the temperature that is detected by the temperature detection section, and
wherein the second driving pulse precedes but occurs within the same periodic time interval as the first driving pulse.

7. The method according to claim 6, wherein each of the waveforms of the first and second driving pulses includes at least a first change portion in which an electric potential changes to a first polarity, a maintaining portion that maintains a final electric potential of the first change portion for a predetermined length of time, and a second change portion in which an electric potential changes from the final electric potential of the maintaining portion to a second polarity opposite to the first polarity, and
wherein correcting the waveform includes changing a duration of at least one of the first change portion, the maintaining portion, and the second change portion of the corrected waveform.

8. The method according to claim 6, wherein correcting the waveform includes changing an amplitude of the corrected waveform.

9. The method according to claim 6, wherein the first driving pulse is a driving pulse that is selected in combination with the second driving pulse by the selection control section, and wherein the waveform of the second driving pulse is the corrected waveform.

10. The method according to claim 6, wherein each of the first and second driving signals includes in each of the periodic time intervals a largest driving pulse that causes a larger amount of pressure to be generated by the pressure generation section than either of the first and second driving pulses taken individually, wherein each of the first and second driving signals further includes, in each of the periodic time intervals, one or more other driving pulses, each of which causes a smaller amount of pressure to be generated by the pressure generation section than either of the first and second driving pulses taken individually,
wherein an interval between generation of the largest driving pulse of the first driving signal and the largest driving pulse of the second driving signal in the periodic time interval is closer to half of the periodic time interval than an interval between generation of the first driving pulse and the second driving pulse,
wherein the interval between generation of the first driving pulse and the second driving pulse in the periodic time interval is shorter than the interval between generation of the largest driving pulses in the periodic time interval, and
wherein another driving pulse or one of the largest driving pulses is generated after both the first driving pulse and the second driving pulse in the periodic time interval.
